(19) United States
(12) Patent Application Publication
(10) Pub. No.: US 2023/0404057 A1
(43) Pub. Date: Dec. 21, 2023

(54) COMPUTER-IMPLEMENTED METHOD FOR APPLYING A PRODUCT ON AN AGRICULTURAL FIELD

(71) Applicant: BASF AGRO TRADEMARKS GMBH, Ludwigshafen am Rhein (DE)

(72) Inventors: Marcel Enzo GAUER, Köln (DE); Carvin Guenther SCHEEL, Köln (DE); Volker NIGGE, Münster (DE)

(21) Appl. No.: 18/033,513

(22) PCT Filed: Oct. 27, 2021
(86) PCT No.: PCT/EP2021/079784

§ 371 Date: Apr. 24, 2023

(30) Foreign Application Priority Data
Oct. 27, 2020 (EP) 20204167.9

(51) Int. Cl. A01M 7/00; A01C 17/00; A01C 21/00; B05B 12/08

(52) U.S. Cl. CPC A01M 7/0092; A01C 17/008; A01C 21/005; B05B 12/081

(57) ABSTRACT

A computer-implemented method for applying a product on an agricultural field, comprising the steps: receiving a control signal to start an adaptation of a product rate and/or of a frequency during a current application of the product on the agricultural field (S10); continuously determining a current amount of the product in a tank of an application device for applying the product (S20); continuously determining a current position of the application device in a route through the agricultural field (S30); continuously adapting the product rate and/or the frequency based on the current position of the application device in the route through the agricultural field and the current amount of the product in the tank of the application device such that at the end of the route of the application device through the agricultural field a predetermined amount of the product is in the tank (S40).

### TECHNICAL FIELD

The present disclosure relates to a computer-implemented method for applying a product on an agricultural field, a system for applying a product on an agricultural field, a use of an application device in such a method, a computer program element for such a method, a control device for such a method.

### TECHNICAL BACKGROUND

Agricultural products such as crop protection products, seeds or fertilizer are indispensable in agriculture due to their impact on yield and have a significant impact on environmental aspects. The application of agricultural products on an agricultural field is therefore an important issue in agricultural. Recommendations how to apply the agricultural products vary from theoretical basis in form of written documents to observations in form of human experts. These recommendations result e.g. in application rate maps for the agricultural product, which are used from a farmer for applying the product on the agricultural field.

It has been found that a further need exists to assist the famer for applying the agricultural product on the agricultural field.

### SUMMARY OF THE INVENTION

It is an object of the present invention to provide a method for applying an agricultural product on the agricultural field. These and other objects, which become apparent upon reading the following description, are solved by the subject matter of the independent claims. The dependent claims refer to preferred embodiments of the invention.

According to a first aspect of the present disclosure a computer-implemented method for applying a product on an agricultural field is provided, comprising the steps: receiving a control signal to start an adaptation of a product rate and/or of a frequency during a current application of the product on the agricultural field; continuously determining a current amount of the product in a tank of an application device for applying the product; continuously determining a current position of the application device in a route through the agricultural field; continuously adapting the product rate and/or the frequency based on the current position of the application device in the route through the agricultural field and the current amount of the product in the tank of the application device such that at the end of the route of the application device through the agricultural field a predetermined amount of the product is in the tank.

The term “product” is to be understood broadly in the present case and comprises any product, which can be applied on an agricultural field. Preferably the products may comprise crop protection products, pesticide, fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, fertilizers, seeds, water, etc.

The term “continuous/continuously” means in the following a recurring activity (e.g. determining the position and adapting the product rate and/or frequency) along the path, whereby the recurring activity may be repeated e.g. every minute, every 30 s or 10 s or 1s or every 100 meter, 10 meter, 5 meter or 1 meter. The term continuous is the opposite of a singular event or uniquely.

The term “product” relates to any physical state of the product, e.g. fluid, rigid or gaseous.

The term “agricultural field” is to be understood broadly in the present case and comprises an area which is configured to serve as basis for growing of agricultural goods, e.g. wheat and rice. The agricultural field may comprise any shape or size. The agricultural field is not limited to a continuous area. The agricultural field may vary in its biological characteristics.

The term “control signal” is to be understood broadly in the present case and comprises any analog or digital signals.

The term “product rate” is in the present case to be understood as amount of a product per an area. The amount may be expressed in kilogram or liters. The area may be expressed in square meter or hectare. The product rate depends on the product and the characteristics of the agricultural field. For example a part of the agricultural field may comprise lots of weed such that the product rate of a specific pesticide may be accordingly high.

The term “frequency” means in the present case the frequency of an application of an application device. For example, in case of an application of a pesticide on an agricultural field, the pesticide may be applied every time a weed is detected. In this case the detection of the weed may be carried out by sensor, wherein the sensor measures for example a reflected light from the weed. The trigger for applying the pesticide may be based on a comparison of the measured reflected light with a threshold. Hence, a change of the threshold is a possibility to adapt the frequency of applying the pesticide on the agricultural field.

The term “tank” is to be understood broadly in the present case and comprises any element configured to store a product. The “term” tank preferably comprises in the present case hollow bodies.

The term “application device” is to be understood broadly in the present case and comprises any device configured to apply a product on an agricultural field. Preferably the term application device comprises sower, fertilizer machine and sprayer. The application device may be self-propelled, towed by tractor or mounted on a tractor.

The term “route” means in the present case a path of the agricultural device through the agricultural field. The route may be derived from tramlines in the field. The route may be a random path through the agricultural field (e.g. in case the agricultural field is a lawn). The route preferably comprises information of a length of the route. The agricultural device moves along the route. Based on the position of the application device along the route and an application width of the application device an area already treated by the application device may be determined. Based on the position of the application device in the route and the application width of the application device the remaining area to be treated by the application device may be determined.

The predetermined amount of the product which should be in the tank at the end of the route can be defined in different ways, e.g. as an absolute number of the product, as product range with a minimum value and a maximum value, as percentage of the tank volume, as percentage range of the tank volume (e.g. 1 to 10 liters/kilograms; 50 liter/kilograms with a tolerance of +/−5 liters/kilograms; between 1.5 and 10% of the total tank volume; etc.). “Predetermined amount” preferably means that 0%, 0.001%, 0.01%, 0.1%, 0.2%, 0.5%, 1%, 2%, 3%, 4%, 5% of the tank is still be filled. The predetermined amount can preferably also be the minimal amount of product in the tank which is technically feasible.

In other words, the invention is based on the knowledge that at the end of the application of the product along the route there is either too much product in the tank of the agricultural device or too little product in the tank of the agricultural device. In case there was too little product in the tank, it was not possible to cover the complete area of the agricultural field with the product. This means that the tank of agricultural device has to be refilled with the product again to apply the remaining area with the product. This is disadvantageous in terms of cost and time and could lead to too little or too much product in the tank. In case there is too much product in the tank at the end of the application, unused amount of the product must be disposed of. This is disadvantageous in terms of disposal costs and time. After receiving a start signal, i.e. a control signal to start an adaptation of a product rate and/or of a frequency during a current application of the product on the agricultural field, the disclosed method determines the current amount of product in the tank and the current position of the agricultural device along the route. For example, the route may be provided by a tramline, a driving path and/or an area already covered reveals in combination with a working width of the application device the already treated area of the application device. Based on the length of route still to be covered and the amount of product still in the tank, the method now adapts the product rate and/or the frequency of the application device inside predefined ranges, such that the amount of the product in the tank has a certain value at the end of the route (e.g. zero or 50 I as buffer). For example, the application rate and/or frequency can be increased, if the amount of product in the tank is too large such that the tank is empty at the end of the route. This could be advantageous as no time consuming and costly disposal of the product is necessary. For example, the application rate and/or frequency can be lowered in case the amount of product in the tank is too low, so that all areas or plants along the route can be treated without refilling the tank. This could be advantageous as it ensures a complete treatment of the area along the route.

In an embodiment, the control signal to start the adaptation of the product rate and/or of the frequency is based on a manual input and/or an automatic input, wherein the automatic input is preferably based on an initial length of the route and the current position of the application device in the route through the agricultural field. The manual input may come from a user, e.g. farmer controlling the agricultural device. The automatic input may be triggered when a certain length of the route is already treated by the application device, preferably 0,5 length of the route, particularly preferred 0,66 length of the route and extremely preferred 0,75 length of the route. The automatic input may be triggered when a certain amount of the area of the agricultural field is already treated, preferably after 50%, particularly preferred after 60% extremely preferred after 75% or 80%. This may be advantageous, as it ensures that the tank may be empty at the end of the route or that the entire area may be treated with the product. The automatic input may be triggered by historical data of previous treatments and data from the current treatment. The automatic input may be triggered based on a machine learning algorithm, wherein the machine learning algorithm may be trained with historical data of previous treatments of the field to be treated. More preferably, the automatic input is not only based on an initial length of the route and the current position of the application device in the route through the agricultural field, but also on the lower and/or upper thresholds of the predefined ranges within which the product rate and/or the frequency is (or is to be) adapted, wherein the lower thresholds is preferably limited based on the product-specific minimum efficacies regarding the application of products on the agricultural field and/or wherein the upper thresholds are preferably limited based on the product-specific environmental impact and/or product-specific regulatory requirements regarding the application of products on the agricultural field.

In an embodiment, the method is provided, wherein continuously determining the current amount of the product in the tank of the application device is based on at least one sensor configured to measure the amount of the product in the tank and/or continuously determining the current amount of the product in the tank of the application device is based on a calculation, based on an initial amount of the product in the tank of the application device and an amount of the product already applied on the agricultural field. The sensor may be a weight sensor, a fill level sensor. The sensor may provide continuously measurement values of the amount of the product in the tank to a determining unit via an interface (e.g. Ethernet, Profibus, etc.). This may be advantageous to precisely determine the amount of the product in the tank of the agricultural device. The initial amount of the product in the tank may be provided by a user input of the farmer or may be provided at a filling station when filling the tank. The amount of the product already applied on the agricultural field may be determined by a flow sensor of the application device, wherein the flow sensor measures the amount of the product already applied. The amount of the product already applied may be determined by integrating a distance of the route already covered with the application device and the corresponding application rates and/or frequency, wherein the application rate and/or frequency may be read out from an application rate map. This may be advantageously due to a cost efficient way to determine the amount of the product in the tank, as no additional sensor are required.

In an embodiment, the method is provided, wherein continuously determining the current position of the application device in the route through the agricultural field is based on a Global Positioning System of the application device and/or a continuous analysis of a movement speed of the application device on the route through the agricultural field. An integration of the movement speed over a time leads to the current position of the application device in the route through the agricultural field. The Global positioning system may be advantageous to precisely determine the position of the application device. The analysis of the movement speed may be a cost effective alternative to determine the position of the application device, as no additional sensors are required.

In an embodiment, the method is provided, wherein the product rate and/or the frequency is adapted within predefined ranges. The predefined ranges may be limited by thresholds, e.g. an upper threshold and a lower threshold, wherein below the lower threshold an application may be useless and above the upper threshold an application may be harmful to the environment. The predefined ranges may comprise more than two thresholds and/or different allowable combinations of thresholds. The upper thresholds may be preferably limited based on the product-specific environmental impact and/or product-specific regulatory requirements regarding the application of products on the agricultural field—especially regarding the application of pesticides, fungicides, herbicides, insecticides, acaricides, molluscicides, nematicides, avicides, piscicides, rodenticides, repellants, bactericides, biocides, safeners —, wherein the product-specific environmental impact and/or product-specific regulatory requirements may additionally also depend on the country, and/or region, and/or on the species, characteristics and/or growth stage of the crop to which the product is to be applied, and/or on the species, characteristics and/or growth stage of the harmful organism (for example weeds, insects, fungi, bacteria) on which the product is targeted. The lower thresholds may be preferably limited based on the product-specific minimum efficacies regarding the application of products on the agricultural field, wherein these product-specific minimum efficacies may additionally also depend on the country, and/or region, and/or on the species, characteristics and/or growth stage of the crop to which the product is to be applied, and/or on the species, characteristics and/or growth stage of the harmful organism (for example weeds, insects, fungi, bacteria) on which the product is targeted. This may be advantageous to increase an efficiency of applying the product on the agricultural field.

In an embodiment, the method is provided, wherein continuously adapting the product rate is further based on an application map of the product for the agricultural field.

The term “application map of the product” comprises in the present case a map comprising product rates along the route. The product rates in the application map may serve as a basis for the adaption, such that product rate may be increased or decreased by e.g. 10% in comparison to the basis. This may be advantageous to reduce a deviation from the initial values of the application map with simultaneous emptying of the tank to the predetermined amount of the product in the tank.

In an embodiment, the method is provided, wherein continuously adapting the frequency comprises the step of adapting a triggering threshold value for triggering the application device to apply the product on the agricultural field, in case a sensor signal is used for triggering an application of the product on the agricultural field. Measuring data from the sensor is compared to the triggering threshold value for triggering the application device. In case the measured data is below or above the threshold value the device is triggered to apply the product on the agricultural field or not. By adapting the threshold value the triggering is adapted and therefore the frequency of applying the product on the agricultural field. E.g. by reducing the triggering threshold also smaller accumulations of weed are detected. This may be advantageous for the targeted application of the product on the weed in the agricultural field with simultaneous emptying of the tank to the predetermined amount of the product in the tank. Preferably, based on the amount applied and/or corresponding product rates and/or corresponding frequency and/or triggering thresholds so far along the route, the amount still to be applied along the remaining route is estimated. Preferably based on the estimate and the current amount of the product in the tank and the current position, the product rate and/or the frequency are continuously adapted.

In an embodiment, the method is provided, wherein the continuously adapting the product rate and/or the frequency is based on a forecast calculation, which is based on an amount of the product already applied on the route through the agricultural field and the remaining route through the agricultural field. The product already applied on the route may be determined by sensors, e.g. weight sensors. The product already applied may be indicative for a distribution of plants (e.g. weed, oils seed rape). Based on the distribution of plants a forecast calculation of the necessary amount for the remaining route may be derived. The forecast calculation may lead advantageously to a precise emptying of product in conjunction with an efficient treatment of the agricultural field.

In an embodiment, the method is provided, wherein the route of the application device is laid out through several physically separated field units. This may be advantageous to increase the efficiency of applying a product on several agricultural fields, as calculation possibilities or the solution space are increased, which may lead to better results.

In an embodiment, the method is provided, wherein continuously adapting the product rate and/or the frequency is further based on a predetermined number of tank fillings or on a predetermined total product quantity. This may advantageous for an increased efficiency, as a larger solution space is considered for adapting the product rate and/or the frequency.

In an embodiment, the method is provided, wherein the product is a crop protection products, pesticide, fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, fertilizer, seed, water, etc.

In an example, the application device is continuously monitored in terms of position, applied amount of product, production rate and/or frequency.

A further aspect of the present disclosure relates to a system for applying a product on an agricultural field, comprising: a receiving unit configured to receive a control signal to start a continuous adaptation of a product rate and/or a frequency during a current application of the product on the agricultural field; a first determining unit configured to continuously determine a current amount of the product in a tank of an application device for applying the product; a second determining unit configured to continuously determine a current position of the application device in a route through the agricultural field; an adapting unit configured to continuously adapt the product rate and/or the frequency based on the current position of the application device in the route through the agricultural field and the current amount of the product in the tank of the application device such that at the end of the route of the application device through the agricultural field a predetermined amount of the product is in the tank. This may be advantageous to increase the efficiency of applying the product on the agricultural field. The receiving unit, the first determining unit, the second determining unit and/or the adapting unit may be separate hardware based CPUs, virtual software units executed one or more hardware CPUs.

A further aspect of the present disclosure relates to a use of an application device in a method described above.

A further aspect of the present disclosure relates to a computer program element configured to carry out steps of the method described above. The computer program element might therefore be stored on a computing unit, which might also be part of an embodiment. This computing unit may be configured to perform or induce performing of the steps of the method described above. Moreover, it may be configured to operate the components of the above described system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

A further aspect of the present disclosure relates to a control device configured to perform steps of the method described above, and a computer-readable medium, which stores the computer program element described above.

### BRIEF DESCRIPTION OF THE DRAWINGS

In the following, the present disclosure is described exemplarily with reference to the enclosed figure, in which

FIG. 1 is a schematic view of a method according to the preferred embodiment of the present disclosure;

FIG. 2 illustrates an exemplary distributed system according to the present disclosure for applying a product on an agricultural field; and

FIG. 3 illustrates a data flow diagram of an example data exchange for providing control data for an application device.

### DETAILED DESCRIPTION OF EMBODIMENT

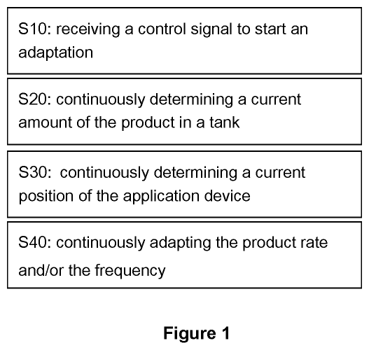

FIG. 1 is a schematic view of a method according to the preferred embodiment of the present disclosure. In the following, an exemplary order of the steps according to the present disclosure is explained. However, the provided order is not mandatory, i.e. all or several steps may be performed in a different order or simultaneously.

The method below can be summarized as follows. The machinery is constantly monitored. Collected information can be product applied per area, position, machinery settings. As soon a start signal, i.e. a control signal to start an adaptation of a product rate and/or of a frequency during a current application of the product on the agricultural field, is received a current amount of a product in a tank of an application device and a current position of the application device in a route through an agricultural field are continuously determined. Based on the current position, a remaining distance along the route is determined. The remaining distance along the route in combination with the working width of the application device corresponds to the untreated area of the agricultural field. Based on the current amount of product in the tank and the distance remaining along the route or the area still to be treated along the route, the product rate and/or frequency of the application device is adapted such that at the end of the route there is a certain amount of the product in the tank. Preferably, based on the amount applied and/or corresponding product rates and/or corresponding frequency so far along the route, the amount still to be applied along the remaining route is estimated. Preferably based on the estimate and the current amount of the product in the tank and the current position, the product rate and/or the frequency are continuously adapted.

In a first step S10, a control signal to start an adaptation of a product rate and/or of a frequency during a current application of the product on the agricultural field is received by receiving unit. The control signal may be a manual input from a user, e.g. a farmer controlling the agricultural device. The control signal may be an automatic control signal, wherein triggered when a certain length of the route is already treated by the application device, e.g. 0.5 length of the route. The product is in the present case an herbicide for treating weeds. The agricultural field is in the present case a continuous field where corn is grown.

In step S20, a current amount of the product in a tank of an application device for applying the product is continuously determined by a first determining unit. In the present example, the current amount of the herbicide in the tank of the application device is determined by a fill level sensor applied on the surface of the tank. The application device in the present example is a sprayer mounted on a tractor.

In step S30, a current position of the application device in a route through the agricultural field is continuously determined by a second determining unit. The route through the agricultural field may describe a predefined path of the agricultural device through the agricultural field and a corresponding length. The position is in the present example determined by a Global Positioning System (i.e. GPS) that is arranged at the application device. Hence, it is possible to determine the remaining length of the route or remaining area to be treated. The route may describe a random path of the agricultural device through the agricultural field. Based on the position it may be determined whether the position is already treated by the application device. Based on the current position and a previous position of the agricultural device further a driving direction of the application device may be determined. Based on the driving direction of the application device a position of the sprayer with its corresponding working width may be determined.

In step S40, the product rate and/or the frequency are continuously adapted by a adaption unit based on the current position of the application device in the route through the agricultural field and the current amount of the product in the tank of the application device such that at the end of the route of the application device through the agricultural field a predetermined amount of the product is in the tank. In the present example of weed control the fill level sensor detects to high amount of the herbicides in the tank of the agricultural device. Hence the frequency is increased by adapting a triggering threshold value for triggering the application device to apply the herbicide on the agricultural field, wherein a weed detection sensor signal is used for triggering an application of the herbicide on the agricultural field. Further the product rate of the herbicide is increased. Hence, it is possible to reduce the current amount of the tank at the end of the route to a certain amount of the product in the tank, e.g. zero. Due to possible fluctuations in the distribution of weeds over the agricultural field, from a certain remaining distance/length of the route in this example the frequency and the product rate are increased to the maximum values (i.e. a so called flat rate mode respectively higher product rate per area; e.g. in the flat rate mode it is possible to increase the frequency to a continuous output of the product and to a higher or maximum output value) to ensure complete emptying of the tank. The maximum values are predefined values for the herbicide and the corn on the agricultural field (i.e. product rate that leads to a damage of corn and/or soil and/or environment).

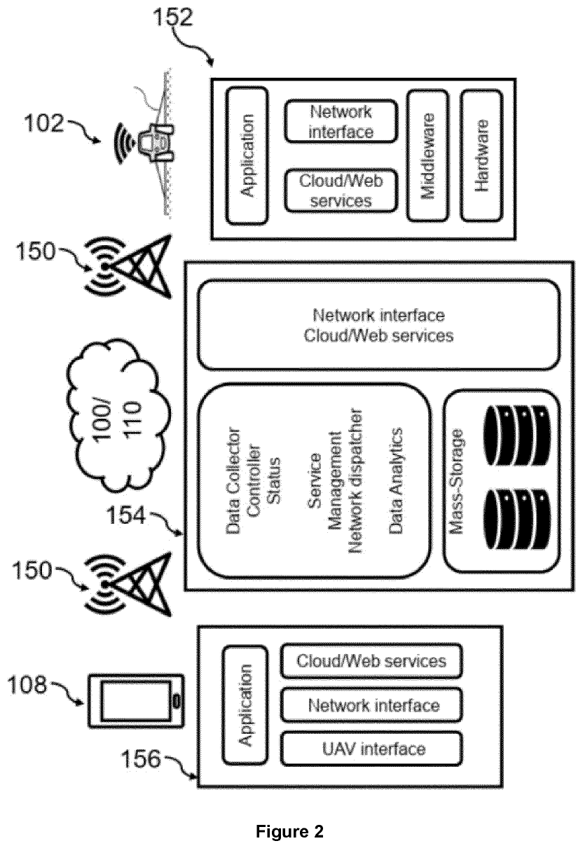

The system illustrated in FIG. 2 shows an exemplary distributed system including an agricultural vehicle/application device 102 (e.g. a tractor for fertilizer spreading), which has been loaded/filled with an agricultural product, e.g. a fertilizer, one or more ground station(s) 110, one or more user device(s) 108, and a cloud environment 100. The application device 102 may be a manned or unmanned vehicle which can be controlled autonomously by onboard computers, remotely by a person or partially remotely e.g. by way of initial operation data. The application device 102 may transmit data signals collected from various onboard sensors and actors mounted to the application device 102. Such data may include current movement data such as current speed, battery or fuel level, position, weather or wind speed, field data including treatment operation data such as treatment type, treatment location or treatment mode, monitoring operation data such as field condition data or location data, and/or operation data, such as initial operation data, updated operation data or current operation data. The application device 102 may directly or indirectly send data signals, such as field data or operation data, to the cloud environment 100, the ground station(s) 110 or other devices/vehicles (not shown). The application device 102 may directly or indirectly receive data signals, such as field data or operation data, from cloud environment 100, the ground station(s) 110 or other agricultural vehicles/devices.

The cloud environment 100 may facilitate data exchange with and between the application/agricultural device(s)/vehicle(s) 102, the ground control station(s) 110, and/or user device(s) 108. The cloud environment 100 may be a server-based distributed computing environment for storing and computing data on multiple cloud servers accessible over the Internet. The cloud environment 100 may be a distributed ledger network that facilitates a distributed immutable database for transactions performed by the application device 102, one or more ground station(s) 110 or one or more user device(s) 108. Ledger network refers to any data communication network comprising at least two network nodes. The network nodes may be configured to a) request the inclusion of data by way of a data block and/or b) verify the requested inclusion of data to the chain and/or c) receiving chain data. In such a distributed architecture, the application device 102, one or more ground station(s) 110, one or more user device(s) 108 may act as nodes storing transaction data in data blocks and participating in a consensus protocol to verify transactions. If the at least two network nodes are in a chain the ledger network may be referred to as a blockchain network. The ledger network 100 may be composed of a blockchain or cryptographically linked list of data blocks created by the nodes. Each data block may contain one or more transactions relating to field data or operation data. Blockchain refers to a continuously extendable set of data provided in a plurality of interconnected data blocks, wherein each data block may comprise a plurality of transaction data. The transaction data may be signed by the owner of the transaction and the interconnection may be provided by chaining using cryptographic means. Chaining is any mechanism to interconnect two data blocks with each other. For example, at least two blocks may be directly interconnected with each other in the blockchain. A hash-function encryption mechanism may be used to chain data blocks in a blockchain and/or to attach a new data block in an existing blockchain. A block may be identified by its cryptographic hash referencing the hash of the preceding block.

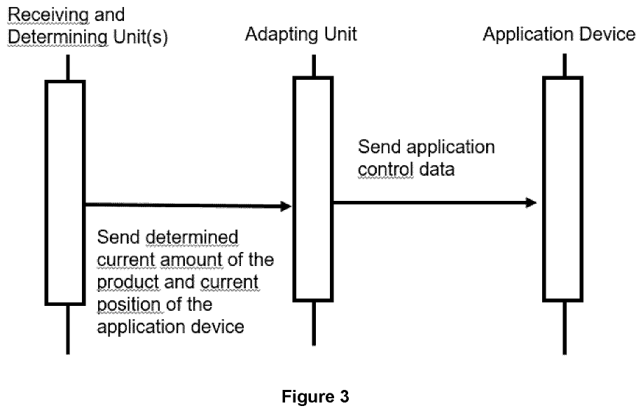

The application device 102 and the ground control station(s) 103 may share data signals with the user device(s) 108 via the cloud environment 100. Communication channels between the nodes and communication channels, between the nodes and the cloud environment 100 may be established through a wireless communication protocol. A cellular network may be established for the application device 102 to ground station 110, other devices/vehicles to cloud environment 100 or ground station 110 to cloud environment 100 communication. Such cellular network may be based any known network technology such as SM, GPRS, EDGE, UMTS/HSPA, LTE technologies using standards like 2G, 3G, 4G or 5G. In a local area of an agricultural field, a wireless local area network (WLAN), e.g. Wireless Fidelity (Wi-Fi), may be established for communication. The cellular network for may be a Flying Ad Hoc Network (FANET). FIG. 3 illustrates one possible data flow diagram of a method for providing control data for an application device for applying a product on an agricultural field. Multiple other embodiments using different parts of the distributed computing environment may be possible and present.

As a first message, a receiving and determining unit may receive a control signal to start an adaptation of a product rate and/or of a frequency during a current application of the product on the agricultural field. After receiving the start signal, i.e. a control signal to start an adaptation of a product rate and/or of a frequency during a current application of the product on the agricultural field, the receiving and determining unit may continuously determining a current amount of the product in a tank of the application device 102 for applying the product and continuously determining a current position of the application device 102 in a route through the agricultural field. This determined current amount of the product in the tank of the application device and the current position of the application device may then be send, by a second massage, to an adapting unit, which is configured to calculate/estimate a continuous adaption of the product rate and/or the frequency based on the current position of the application device 102 in the route through the agricultural field and the current amount of the product in the tank of the application device in such a ways that at the end of the route of the application device 102 through the agricultural field a predetermined amount of the product is in the tank. As a third message, respective control signals may be provided to a controller device of the application device 102 controlling application means of the application device 102.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the steps S10 to S40 can be performed in any order, i.e. the present invention is not limited to a specific order of these steps. Moreover, it is also not required that the different steps are performed at a certain place or at one place, i.e. each of the steps may be performed at a different place using different equipment/data processing units. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

S10 receiving a control signal to start an adaptation
S20 continuously determining a current amount of the product in a tank
S30 continuously determining a current position of the application device
S40 continuously adapting the product rate and/or the frequency

1. A computer-implemented method for applying a product on an agricultural field, the method comprising:
receiving a control signal to start an adaptation of a product rate and/or of a frequency during a current application of the product on the agricultural field (S10);
continuously determining a current amount of the product in a tank of an application device for applying the product (S20);
continuously determining a current position of the application device in a route through the agricultural field (S30); and
continuously adapting the product rate and/or the frequency based on the current position of the application device in the route through the agricultural field and the current amount of the product in the tank of the application device such that at the end of the route of the application device through the agricultural field a predetermined amount of the product is in the tank (S40).

2. The method according to claim 1, wherein the control signal to start the adaptation of the product rate and/or of the frequency is based on a manual input and/or an automatic input, wherein the automatic input is based on an initial length of the route and the current position of the application device in the route through the agricultural field.

3. The method according to claim 1, wherein continuously determining the current amount of the product in the tank of the application device is based on at least one sensor configured to measure the amount of the product in the tank and/or continuously determining the current amount of the product in the tank of the application device is based on a calculation, based on an initial amount of the product in the tank of the application device and an amount of the product already applied on the agricultural field.

4. The method according to claim 1, wherein continuously determining the current position of the application device in the route through the agricultural field is based on a Global Positioning System of the application device and/or a continuous analysis of a movement speed of the application device on the route through the agricultural field.

5. (canceled)

6. The method according to claim 1, wherein continuously adapting the product rate is further based on an application map of the product for the agricultural field.

7. The method according to claim 1, wherein continuously adapting the frequency comprises the step of adapting a triggering threshold value for triggering the application device to apply the product on the agricultural field, in case a sensor signal is used for triggering an application of the product on the agricultural field.

8. The method according to claim 1, wherein the continuously adapting the product rate and/or the frequency is based on a forecast calculation, which is based on an amount of the product already applied on the route through the agricultural field and the remaining route through the agricultural field.

9. The method according to claim 1, wherein the route of the application device is laid out through several physically separated field units.

10. The method according to claim 1, wherein continuously adapting the product rate and/or the frequency is further based on a predetermined number of tank fillings or on a predetermined total product quantity.

11. The method according to claim 1, wherein the product is a crop protection product, pesticide, fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, fertilizer, seeds and/or water.

12. A system for applying a product on an agricultural field, the system comprising:
a receiving unit configured to receive a control signal to start a continuous adaptation of a product rate and/or a frequency during a current application of the product on the agricultural field;
a first determining unit configured to continuously determine a current amount of the product in a tank of an application device for applying the product;
a second determining unit configured to continuously determine a current position of the application device in a route through the agricultural field; and
an adapting unit configured to continuously adapt the product rate and/or the frequency based on the current position of the application device in the route through the agricultural field and the current amount of the product in the tank of the application device such that at the end of the route of the application device through the agricultural field a predetermined amount of the product is in the tank.

13. Use of an application device in a method according to claim 1.

14. A non-transitory computer-readable medium having instructions encoded thereon that, when executed by a processing device, cause the processing device to carry out steps of the method according to claim 1.

15. A control device configured to perform steps of the method according to claim 1.

16. An application device for applying a product on an agricultural field controlled based on instructions provided by a method according to claim 1.
